(19) United States
(12) Patent Application Publication
(10) Pub. No.: US 2014/0168082 A1
(43) Pub. Date: Jun. 19, 2014

(54) SCROLLING SIGNAL GENERATION METHOD

(71) Applicant: PRIMAX ELECTRONICS LTD., Taipei (TW)

(72) Inventor: Chien-Nan Lin, Taipei (TW)

(73) Assignee: PRIMAX ELECTRONICS LTD., Taipei (TW)

(21) Appl. No.: 13/837,067

(22) Filed: Mar. 15, 2013

(30) Foreign Application Priority Data
Dec. 19, 2012 (TW) 101148406

(51) Int. Cl. G06F 3/038

(52) U.S. Cl. CPC G06F 3/0383
USPC 345/166

(57) ABSTRACT

A scrolling signal generation method is provided. A look-up table has been previously established. By inquiring the look-up table, a controlling unit judges whether the received plural phase signals can be collaboratively defined as a scrolling signal. If one of the phase signals received by the controlling unit is lost because of the noise, the controlling unit compares the plural phase signals with plural scrolling data of the look-up table. If the plural phase signals comply with plural scrolling data of the look-up table, the plural phase signals are defined as the scrolling signal. Consequently, the optical scroll wheel using the scrolling signal generation method of the present invention can be smoothly operated without causing the erroneous action.

### FIELD OF THE INVENTION

The present invention relates to a scrolling signal generation method, and more particularly to a scrolling signal generation method for an optical wheel mouse.

### BACKGROUND OF THE INVENTION

The widely-used input devices of a computer system include for example a mouse, a keyboard, a touchpad, or the like. Among these input devices, the mouse is the most prevailing because it is very easy-to-use. When a mouse is held on the palm of a user's hand, the mouse may be intuitively operated to control movement of the cursor shown on the display screen of the computer system.

Hereinafter, the structures and the functions of a conventional mouse will be illustrated with reference to a wheel mouse as shown in FIG. 1. FIG. 1 schematically illustrates the communication between a conventional wheel mouse and a computer system. The computer system 2 comprises a computer host 21 and a display screen 22. The computer host 21 is in communication with the wheel mouse 1 and the display screen 22. The computer host 21 has a connecting port 211. A graphic-based window 221 and a cursor 222 are displayed on the display screen 22. The wheel mouse 1 is used for controlling the cursor 222 to have the computer host 21 execute a corresponding command. The wheel mouse 1 comprises a casing 10, a left button 11, a right button 12, a scroll wheel 13, an optical displacement sensing module (not shown), a wireless signal transmitter 14, and a wireless signal receiver 15. The casing 10 is used for supporting a user's palm. When the casing 10 is moved by the user, the optical displacement sensing module at the bottom of the casing 10 generates a displacement signal according to the movement of the casing 10. According to the displacement signal, the movement of the cursor 222 is correspondingly controlled. By clicking the left button 11 or the right button 12, a corresponding button signal is issued to the computer host 21. According to the button signal, the computer host 21 executes a corresponding command. The scroll wheel 13 is arranged between the left button 11 and the right button 12. By rotating the scroll wheel 13, a corresponding scrolling signal is generated. According to the scrolling signal, the graphic-based window 221 shown on the display screen 22 may be scrolled upwardly or downwardly by the computer host 21. The wireless signal transmitter 14 is disposed within the casing 10 for transmitting the displacement signal, the button signal and the scrolling signal. The wireless signal receiver 15 is inserted into the connecting port 211. Consequently, the wireless signal receiver 15 is in communication with the computer host 21 for receiving the displacement signal, the button signal and the scrolling signal from the wireless signal transmitter 14 and transmitting these signals to the computer host 21

Since the scroll wheel 13 is a mechanical scroll wheel, the rotation of the scroll wheel 13 may provide a tactile feel to the user. Due to the tactile feel, the user may feel the graduation feedback of rotating the scroll wheel 13. However, since the rotation of the mechanical scroll wheel also generates a clicking sound, some users may be annoyed at the clicking sound. For solving this drawback, an optical wheel mouse with an optical scroll wheel is introduced into the market. During rotation of the optical scroll wheel, neither the tactile feel nor the clicking sound is generated.

FIG. 2 is a schematic perspective view illustrating a portion of an optical scroll wheel of a conventional optical wheel mouse. In FIG. 2, an optical scroll wheel 23, a light emitter 24 and a light receiver 25 are shown. The optical scroll wheel 23 has a grating structure 231. The grating structure 231 is disposed within the optical scroll wheel 23. The grating structure 231 comprises plural elongated strips 2311. The light emitter 24 is located at a side of the optical scroll wheel 23 for generating an optical signal (not shown). The optical signal is projected to the grating structure 231 of the optical scroll wheel 23. For example, the light emitter 24 is an infrared light emitter, and the optical signal is an infrared optical signal.

The light receiver 25 is located at another side of the optical scroll wheel 23 for receiving the optical signal that passes through the gaps between the plural elongated strips 2311. During the optical scroll wheel 23 is rotated, the grating structure 231 is correspondingly moved in response to the rotation of the optical scroll wheel 23. Consequently, at a first time spot, the optical signal from the light emitter 24 is transferred through one of the gaps between plural elongated strips 2311 and received by the light receiver 25. At a second time spot after the first time spot, the optical signal is blocked by the plural elongated strips 2311 and thus unable to be received by the light receiver 25. According to the optical signal which is discontinuously received by the light receiver 25, the conventional optical wheel mouse (not shown) generates a scrolling signal. In addition, the scrolling signal is transmitted to the computer host. According to the scrolling signal, the graphic-based window is correspondingly scrolled by the computer host. A scrolling signal is equivalent to a rotating graduation of the optical scroll wheel 23.

The operating principles of the optical scroll wheel 23 will be illustrated in more details as follows. FIGS. 3A˜3D schematically illustrate some conditions of generating different output signals by the light receiver of the conventional optical wheel mouse in response to the rotation of the optical scroll wheel. As shown in FIG. 3A, after the optical signal is received by the light receiver 25, the light receiver 25 generates plural phases signals. The light receiver 25 is in communication with a controlling unit 26 of the conventional optical wheel mouse. After the plural signals from the light receiver 25 are received by the controlling unit 26, the controlling unit 26 generates a scrolling signal. The light receiver 25 has a first pin 251 and a second pin 252. The first pin 251 and the second pin 252 are in communication with the controlling unit 26. According to the relationship between the position of a specified elongated strip 2311 and the light receiver 25, the first pin 251 and the second pin 252 output a first logic level signal and a second logic level signal, respectively. The first logic level signal and the second logic level signal are collaboratively defined as one phase signal. Moreover, plural phase signals are collaboratively defined as a scrolling signal.

As shown in FIG. 3A, the elongated strip 2311 is located at a position corresponding to a middle region of the light receiver 25. Meanwhile, the optical signal (not shown) from the light emitter 24 is blocked by the elongated strip 2311. Since the optical signal fails to be received by the light receiver 25, the light receiver 25 generates a first phase signal. The first phase signal is defined by a first low logic level signal and a second low logic level signal collaboratively. The first low logic level signal (i.e. with the logic value “0”) is generated by the first pin 251, and the second low logic level signal (i.e. with the logic value “0”) is generated by the second pin 252. In other words, the first phase signal received by the controlling unit 26 is (0, 0).

Next, as shown in FIG. 3B, the optical scroll wheel 23 is continuously rotated, and thus the elongated strip 2311 is moved to a position corresponding to a front end of the light receiver 25 (i.e. at the position corresponding to the first pin 251). Meanwhile, the optical signal from the light emitter 24 is partially blocked by the elongated strip 2311. Consequently, the optical signal fails to be received by the front end of the light receiver 25, but the optical signal can still be received by a rear end of the light receiver 24 (i.e. at the position corresponding to the second pin 252). Under this circumstance, the light receiver 25 generates a second phase signal. The second phase signal is defined by a first low logic level signal and a second high logic level signal collaboratively. The first low logic level signal (i.e. with the logic value “0”) is generated by the first pin 251, and the second high logic level signal (i.e. with the logic value “1”) is generated by the second pin 252. In other words, the second phase signal received by the controlling unit 26 is (0, 1).

As shown in FIG. 3C, the optical scroll wheel 23 is continuously rotated. Consequently, the elongated strip 2311 is moved to a position near the light receiver 25, but and has not been transferred through the light receiver 25. Meanwhile, since the optical signal from the light emitter 24 is not blocked by the elongated strip 2311, the optical signal can be received by the light receiver 25. Under this circumstance, the light receiver 25 generates a third phase signal. The third phase signal is defined by a first high logic level signal and a second high logic level signal collaboratively. The first high logic level signal (i.e. with the logic value “1”) is generated by the first pin 251, and the second high logic level signal (i.e. with the logic value “1”) is generated by the second pin 252. In other words, the third phase signal received by the controlling unit 26 is (1, 1).

Next, as shown in FIG. 3D, the optical scroll wheel 23 is continuously rotated, and thus the elongated strip 2311 is moved to a position corresponding to a rear end of the light receiver 25. Meanwhile, the optical signal from the light emitter 24 is partially blocked by the elongated strip 2311. Consequently, the optical signal can be received by the front end of the light receiver 25, but the optical signal fails to be received by the rear end of the light receiver 25. Under this circumstance, the light receiver 25 generates a fourth phase signal. The fourth phase signal is defined by a first high logic level signal and a second low logic level signal collaboratively. The first high logic level signal (i.e. with the logic value “1”) is generated by the first pin 251, and the second low logic level signal (i.e. with the logic value “0”) is generated by the second pin 252. In other words, the third phase signal received by the controlling unit 26 is (1, 0).

The optical scroll wheel 23 is continuously rotated and the above operating sequence is continuously performed to generate the phase signals until the rotation of the optical scroll wheel 23 is stopped.

From the above discussions, in response to each rotation of the optical scroll wheel 23, the phase signals received by the controlling unit 26 is switched from (0, 0) to (1, 0), then switched to (1, 1), and finally switched to (1, 0). That is, once the plural phase signals generated by the light receiver 25 are switched according to a complete operating sequence of (0, 0)→(0, 1)→(1, 1)→(1, 0), the scrolling signal defined by the plural phase signals is outputted from the controlling unit 26. The generation of the scrolling signal is equivalent to one rotating graduation of the conventional mechanism scroll wheel 13.

However, unlike the mechanical scroll wheel, the rotation of the optical scroll wheel 23 does not provide the tactile feel. If the rotation of the optical scroll wheel 23 fails to successfully generate the continuous phase signals because of noise interference, the controlling unit 26 that is in communication with the optical scroll wheel 23 can not output a corresponding scrolling signal. Under this circumstance, an erroneous action may occur. For example, during normal operations of the optical scroll wheel 23, the plural phase signals generated by the light receiver 25 are sequentially switched according to a complete operating sequence of (0, 0)→(0, 1)→(1, 1)→(1, 0). If the rotation of the optical scroll wheel 23 is influenced by the noise interference, a specified phase signal (e.g. the second phase signal) generated by the light receiver 25 fails to be transmitted to the controlling unit 26. Since the plural phase signals received by the controlling unit 26 are switched according to the sequence of (0, 0)→(1, 1)→(1, 0). Under this circumstance, the scrolling signal fails to be outputted from the controlling unit 26, and an erroneous action occurs. Due to the erroneous action, the operation of the optical scroll wheel 23 is interrupted, and thus the user feels that the operation is not smooth.

Therefore, there is a need of provide a scrolling signal generation method in order to avoid generation of the erroneous action.

### SUMMARY OF THE INVENTION

The present invention provides a scrolling signal generation method for avoiding generation of an erroneous action.

In accordance with an aspect of the present invention, there is provided a scrolling signal generation method for an optical wheel mouse. The optical wheel mouse includes an optical scroll wheel, a light emitter and a light receiver. The scroll wheel is rotatable by a user. The light emitter generates an optical signal. The optical signal passing through the scroll wheel is received by the light receiver. The light receiver outputs plural phase signals according to the optical signal. The scrolling signal generation method includes the following steps. Firstly, a judging step is performed to judge whether the phase signal from the light receiver is changed. Then, a judging step is performed to judge whether a number of times the phase signal is changed reaches a predetermined value. If the number of times the phase signal is changed reaches the predetermined value, a first look-up table is inquired. The first look-up table contains plural first scrolling data, and each of the plural first scrolling data is defined by plural phase signals. Then, a judging step is performed to judge whether the plural phase signals generated in response to rotation of the optical scroll wheel comply with the plural first scrolling data of the first look-up table. If the plural phase signals comply with the plural first scrolling data of the first look-up table, a scrolling signal corresponding to the plural phase signals is outputted. If the plural phase signals do not comply with the plural first scrolling data of the first look-up table, the number of times the phase signal is changed is zeroed and the current phase signal is recorded, and the step of judging whether the phase signal from the light receiver is changed is performed again.

In an embodiment, if the phase signal is not changed, the scrolling signal generation method further includes a step of calculating a time period of maintaining an idle status of the optical scroll wheel. If the phase signal is changed, the scrolling signal generation method further includes a step of recording the number of times the phase signal is changed.

In an embodiment, after the step of calculating the time period of maintaining the idle status of the optical scroll wheel, the scrolling signal generation method further includes a step of judging whether the time period of maintaining the idle status of the optical scroll wheel reaches a predetermined time period. If the time period of maintaining the idle status of the optical scroll wheel reaches the predetermined time period, the optical scroll wheel is controlled to enter a sleep mode. If the time period of maintaining the idle status of the optical scroll wheel does not reach the predetermined time period, the step of judging whether the phase signal from the light receiver is changed is performed again.

In an embodiment, if the number of times the phase signal is changed does not reach the predetermined value, the step of judging whether the phase signal from the light receiver is changed is performed again.

In an embodiment, after the scrolling signal corresponding to the plural phase signals is outputted, the step of judging whether the phase signal from the light receiver is changed is performed again.

In accordance with another aspect of the present invention, there is provided a scrolling signal generation method for an optical wheel mouse. The optical wheel mouse includes an optical scroll wheel, a light emitter and a light receiver. The scroll wheel is rotatable by a user. The light emitter generates an optical signal. The optical signal passing through the scroll wheel is received by the light receiver. The light receiver outputs plural phase signals according to the optical signal. The scrolling signal generation method includes the following steps. Firstly, a judging step is performed to judge whether the phase signal from the light receiver is changed. Then, a first look-up table or a second look-up table is selectively inquired. If the number of times the phase signal is changed reaches a first predetermined value and a time period of maintaining an idle status of the optical scroll wheel reaches a predetermined time period, the first look-up table is inquired. If the number of times the phase signal is changed reaches a second predetermined value which is larger than the first predetermined value, the second look-up table is inquired. The first look-up table contains plural first scrolling data, and each of the plural first scrolling data is defined by M phase signals. The second look-up table contains plural second scrolling data, and each of the plural second scrolling data is defined by N phase signals, where N is larger than M. Then, a judging step is performed to judge whether the plural phase signals generated in response to rotation of the optical scroll wheel comply with the plural first scrolling data of the first look-up table or comply with the plural second scrolling data of the second look-up table. Then, a first scrolling signal corresponding to the plural phase signals or a second scrolling signal corresponding to the plural phase signals is outputted.

In an embodiment, if the phase signal is not changed, the scrolling signal generation method further includes a step of calculating the time period of maintaining the idle status of the optical scroll wheel. If the phase signal is changed, the scrolling signal generation method further includes a step of recording the number of times the phase signal is changed.

In an embodiment, after the step of calculating the time period of maintaining the idle status of the optical scroll wheel, the scrolling signal generation method further includes a step of judging whether the first look-up table is inquired. After the step of recording the number of times the phase signal is changed, the scrolling signal generation method further includes a step of judging whether the second look-up table is inquired.

In an embodiment, the step of judging whether the first look-up table is inquired is performed by steps of judging whether the number of times the phase signal is changed reaches the first predetermined value, and judging whether the time period of maintaining the idle status of the optical scroll wheel reaches the predetermined time period.

In an embodiment, if the number of times the phase signal is changed does not reach the first predetermined value, the step of judging whether the phase signal from the light receiver is changed is performed again. If the number of times the phase signal is changed reaches the first predetermined value, the step of judging whether the time period of maintaining the idle status of the optical scroll wheel reaches the predetermined time period is performed.

In an embodiment, if the time period of maintaining the idle status of the optical scroll wheel reaches the predetermined time period, the first look-up table is inquired. If the time period of maintaining the idle status of the optical scroll wheel does not reach the predetermined time period, the step of judging whether the phase signal from the light receiver is changed is performed again.

In an embodiment, if the number of times the phase signal is changed does not reach the second predetermined value, the step of judging whether the phase signal from the light receiver is changed is performed again.

In an embodiment, after the first scrolling signal corresponding to the plural phase signals or the first scrolling signal corresponding to the plural phase signals is outputted, the step of judging whether the phase signal from the light receiver is changed is performed again.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the communication between a conventional wheel mouse and a computer system;

FIG. 2 is a schematic perspective view illustrating a portion of an optical scroll wheel of a conventional optical wheel mouse;

FIGS. 3A˜3D schematically illustrate some conditions of generating different output signals by the light receiver of the conventional optical wheel mouse in response to the rotation of the optical scroll wheel;

FIG. 4 is a schematic function block diagram illustrating the communication between an optical wheel mouse and a computer system according to a first embodiment of the present invention;

FIGS. 5A and 5B schematically illustrate a flowchart of a scrolling signal generation method for the optical wheel mouse of the first embodiment of the present invention;

FIG. 6 is a schematic function block diagram illustrating the communication between an optical wheel mouse and a computer system according to a second embodiment of the present invention; and

FIGS. 7A and 7B schematically illustrate a flowchart of a scrolling signal generation method for the optical wheel mouse of the second embodiment of the present invention. The scrolling signal generation method comprises the following steps.

### DETAILED DESCRIPTION OF THE PREFERRED EMBODIMENT

The present invention provides a scrolling signal generation method.

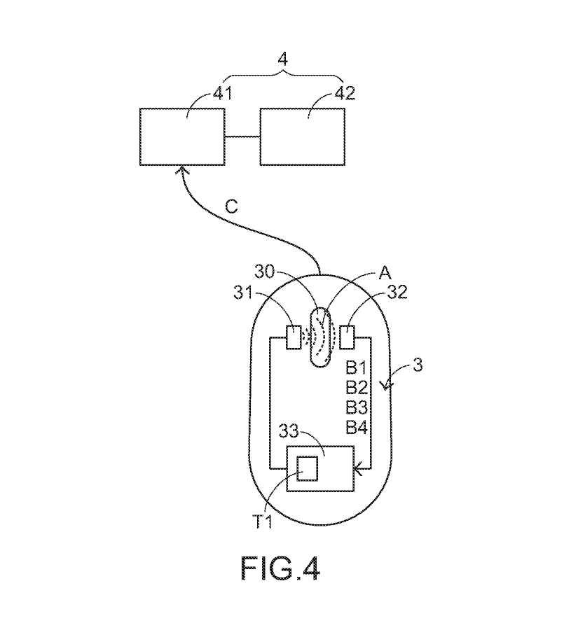

FIG. 4 is a schematic function block diagram illustrating the communication between an optical wheel mouse and a computer system according to a first embodiment of the present invention. In FIG. 4, an optical wheel mouse 3 and a computer host 4 are shown. The computer system 4 comprises a computer host 41 and a display screen 42. The optical wheel mouse 3 is in communication with the computer host 41 of the computer system 4. The optical wheel mouse 3 comprises an optical scroll wheel 30, a light emitter 31, a light receiver 32, and a controlling unit 33. The structures of other components of the optical wheel mouse 3 and the structures of the computer host 41 and the display screen 42 are similar to those of the similar to those of the conventional computer host and the conventional display screen, and are not redundantly described herein.

When the optical scroll wheel 30 is rotated by the user, the optical scroll wheel 30 is triggered. The light emitter 31 is located at a first side of the optical scroll wheel 30 for generating an optical signal A. The optical signal A is projected to the optical scroll wheel 30. The light receiver 32 is located at a second side of the optical scroll wheel 30 for receiving the optical signal A from the light emitter 31. According to the optical signal A, the light receiver 32 generates plural phase signals to the controlling unit 33.

The logic level signals outputted from a first pin (not shown) and a second pin (not shown) of the light receiver 32 are defined as a corresponding phase signal. The operating principles of generating the logic level signals by the optical wheel mouse 3 are similar to those of the conventional technology, and are not redundantly described herein. The controlling unit 33 is in communication with the light emitter 31 and the light receiver 32. The controlling unit 33 is used for receiving plural phase signals. According to the plural phase signals, the controlling unit 33 will judge whether the optical scroll wheel 30 is triggered. When the optical scroll wheel 30 is triggered, the controlling unit 33 issues a scrolling signal C. The scrolling signal C is defined by plural phase signals collaboratively. In this embodiment, the light emitter 31 is an infrared light emitter, and the optical signal A is an infrared optical signal. Moreover, the light receiver 32 is an infrared light receiver, and the controlling unit 33 is a microprocessor.

Before the scrolling signal generation method of the present invention is performed, a first look-up table T1 has been established and stored in the controlling unit 33. The first look-up table T1 comprises plural first scrolling data. Each of the first scrolling data is defined by plural phase signals. These phase signals comprise four kinds of phase signals, including a first phase signal B1, a second phase signal B2, a third phase signal B3 and a fourth phase signal B4.

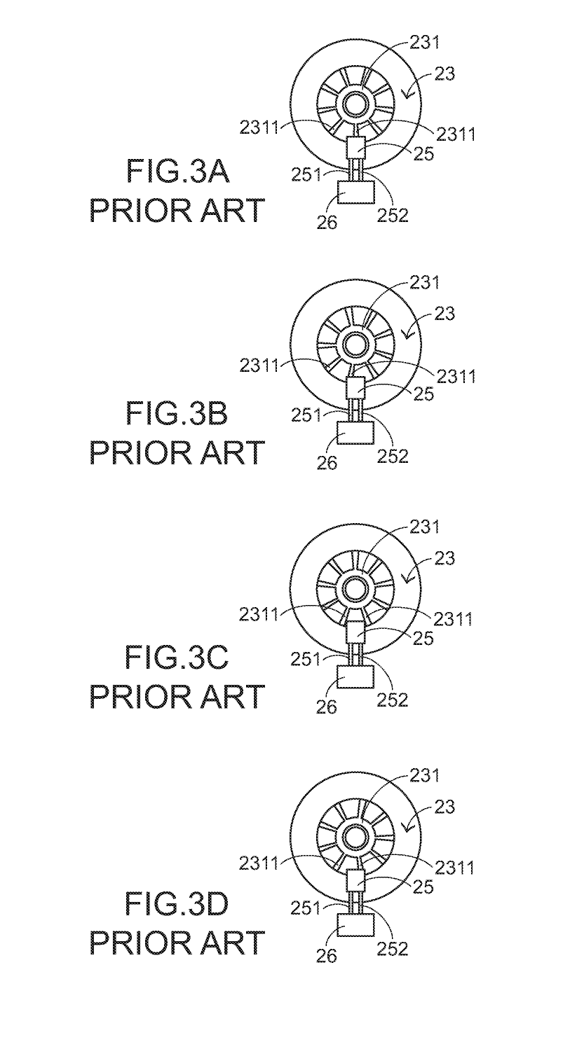

Like the conventional technology as shown in FIG. 3A, the first phase signal is defined by a first low logic level signal and a second low logic level signal collaboratively. The first low logic level signal (i.e. with the logic value “0”) is generated by the first pin, and the second low logic level signal (i.e. with the logic value “0”) is generated by the second pin. In other words, the first phase signal is (0, 0). Like the conventional technology as shown in FIG. 3B, the second phase signal is defined by a first low logic level signal (i.e. with the logic value “0”) and a second high logic level signal (i.e. with the logic value “1”) collaboratively. In other words, the second phase signal is (0, 1). Like the conventional technology as shown in FIG. 3C, the third phase signal is defined by a first high logic level signal (i.e. with the logic value “1”) and a second high logic level signal (i.e. with the logic value “1”) collaboratively. In other words, the third phase signal is (1, 1). Like the conventional technology as shown in FIG. 3D, the fourth phase signal is defined by a first high logic level signal (i.e. with the logic value “1”) and a second low logic level signal (i.e. with the logic value “0”) collaboratively. In other words, the fourth phase signal is (1, 0). The detailed contents of the plural first scrolling data of the first look-up table T1 will be illustrated later.

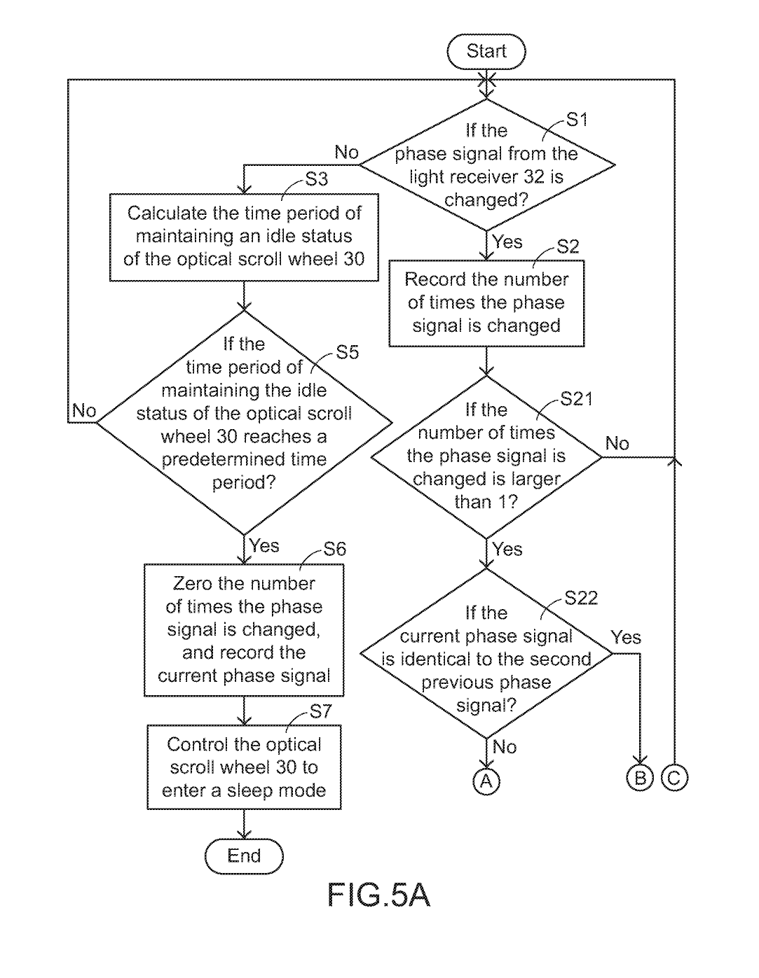

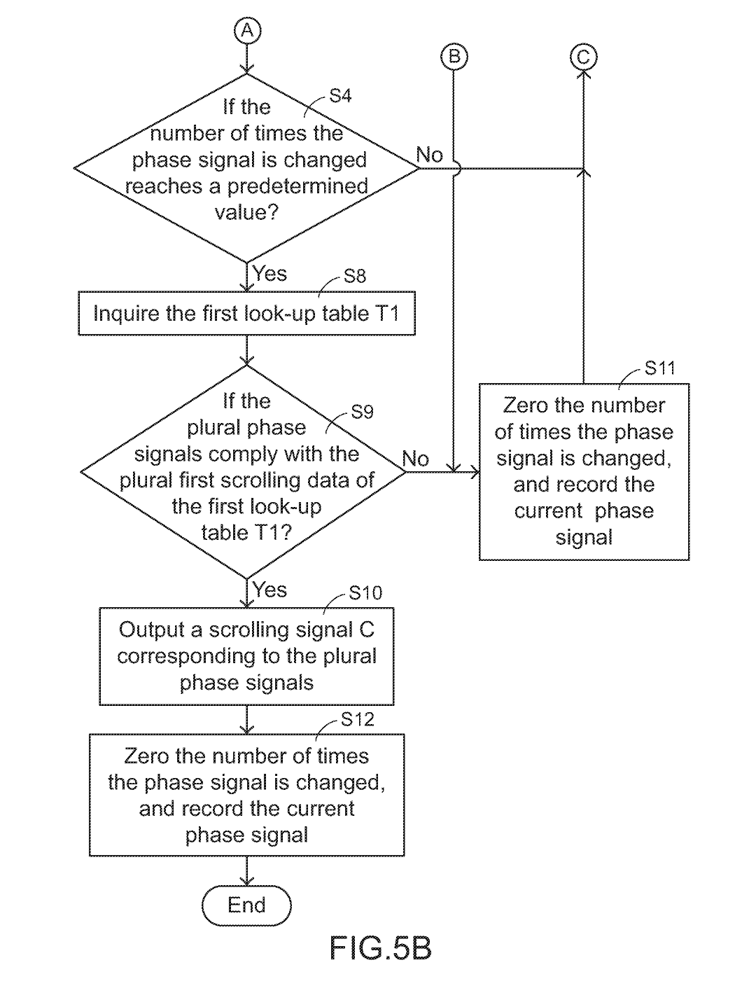

Hereinafter, a scrolling signal generation method for the optical wheel mouse of the first embodiment of the present invention will be illustrated with reference to FIGS. 5A and 5B. FIGS. 5A and 5B schematically illustrate a flowchart of a scrolling signal generation method for the optical wheel mouse of the first embodiment of the present invention. The scrolling signal generation method comprises the following steps.

The step S1 is performed to judge whether the phase signal from the light receiver 32 is changed. In the step S2, the number of times the phase signal is changed is recorded. In the step S3, the time period of maintaining an idle status of the optical scroll wheel 30 is calculated. The step S4 is performed to judge whether the number of times the phase signal is changed reaches a predetermined value. The step S5 is performed to judge whether the time period of maintaining the idle status of the optical scroll wheel 30 reaches a predetermined time period. In the step S6, the number of times the phase signal is changed is zeroed, and the current phase signal is recorded. In the step S7, the optical wheel mouse 3 is controlled to enter a sleep mode. In the step S8, the first look-up table T1 is inquired. The step S9 is performed to judge whether plural phase signals comply with the plural first scrolling data of the first look-up table T1. In the step S10, a scrolling signal C corresponding to the plural phase signals is outputted. In the step S11, the number of times the phase signal is changed is zeroed, and the current phase signal is recorded. In the step S12, the number of times the phase signal is changed is zeroed, and the current phase signal is recorded.

The scrolling signal generation method of the present invention further comprises a reverse rotation judgment mechanism. The reverse rotation judgment mechanism is performed after the step S2. The reverse rotation judgment mechanism comprises the steps S21 and S22. The step S21 is performed to judge whether the number of times the phase signal is changed is larger than 1. The step S22 is performed to judge whether the current phase signal is identical to the second previous phase signal. In an embodiment, the predetermined value is three, and the predetermined time period is 2 seconds. The predetermined value and the predetermined time period are previously set in the controlling unit 33 during the process of fabricating the optical wheel mouse 3.

In the step S1, if the phase signal is changed, the step S2 is performed. Whereas, if the phase signal is not changed, the step S3 is performed. In the step S5, if the time period of maintaining the idle status of the optical scroll wheel 30 reaches the predetermined time period, the step S6 is performed. Whereas, if the time period of maintaining the idle status of the optical scroll wheel 30 does not reach the predetermined time period, the step S1 is performed again. In the step S4, if the number of times the phase signal is changed reaches the predetermined value, the step S8 is performed. Whereas, if the number of times the phase signal is changed does not reach the predetermined value, the step S1 is performed again. In the step S9, if the plural phase signals comply with the plural first scrolling data of the first look-up table T1, the step S10 is performed. Whereas, if the plural phase signals do not comply with the plural first scrolling data of the first look-up table T1, the step S11 is performed. After the optical wheel mouse 3 enters the sleep mode in the step S7, if the optical wheel mouse 3 is triggered again, the step S1 is automatically executed by the optical wheel mouse 3 again. The operating principles of the sleep mode are well known in those skilled in the art. In the step S21, if the number of times the phase signal is changed is not larger than 1, the step S1 is performed again. Whereas, if the number of times the phase signal is changed is larger than 1, the step S22 is performed. In the step S22, if the current phase signal is identical to the second previous phase signal, it means that the optical scroll wheel 30 is firstly rotated in a specified direction and then the optical scroll wheel 30 is rotated in the direction reverse to the specified direction, and thus the step S11 is performed. Whereas, if the current phase signal is identical to the second previous phase signal, the step S4 is performed.

The details contents of the plural first scrolling data of the first look-up table T1 will be illustrates as follows. The plural first scrolling data have been previously stored in the controlling unit 33. Each of the plural first scrolling data may be considered as a rotating graduation, i.e. a scrolling signal. The plural first scrolling data comprise 32 kinds of combinations. The first kind of the first scrolling data is a sequential combination of a first phase signal B1, a second phase signal B2, a third phase signal B3 and a fourth phase signal B4. That is, the first kind of the first scrolling data is indicated as B1→B2→B3→B4. The contents of the plural first scrolling data of the first look-up table T1 are listed in the following table.

| | |
|---|---|
| B1→B2→B3→B4 | B4→B3→B2→B1 |
| B2→B3→B4→B1 | B1→B4→B3→B2 |
| B3→B4→B1→B2 | B2→B1→B4→B3 |
| B4→B1→B2→B3 | B3→B2→B1→B4 |
| B1→B2→B3→B1 | B1→B3→B2→B1 |
| B1→B2→B4→B1 | B1→B4→B2→B1 |
| B1→B3→B4→B1 | B1→B4→B3→B1 |
| B2→B3→B4→B2 | B2→B4→B3→B2 |
| B2→B3→B1→B2 | B2→B1→B3→B2 |
| B2→B4→B1→B2 | B2→B1→B4→B2 |
| B3→B4→B1→B3 | B3→B1→B4→B3 |
| B3→B4→B2→B3 | B3→B2→B4→B3 |
| B3→B1→B2→B3 | B3→B2→B1→B3 |
| B4→B1→B2→B4 | B4→B2→B1→B4 |
| B4→B1→B3→B4 | B4→B3→B1→B4 |
| B4→B2→B3→B4 | B4→B3→B2→B4 |

The plural first scrolling data in the left column of the first look-up table T1 denote the sequential combinations of the plural phase signals which are generated in response to the rotation of the optical scroll wheel 30 along a first direction. The plural first scrolling data in the right column of the first look-up table T1 denote the sequential combinations of the plural phase signals which are generated in response to the rotation of the optical scroll wheel 30 along a second direction, wherein the second direction is reverse to the first direction.

Hereinafter, the operations of the scrolling signal generation method according to the present invention will be illustrated with reference to FIGS. 4, 5A and 5B again. If the optical scroll wheel 30 is not triggered, it is assumed that the phase signal generated by the light receiver 32 is the first phase signal B1. That is, the first phase signal B1 is (0, 0). After the optical wheel mouse 3 is electrically powered on, the scrolling signal generation method of the present invention is started. Firstly, the controlling unit 33 judges whether the phase signal from the light receiver 32 is changed (Step S1). When the optical scroll wheel 30 is rotated by the user, the light receiver 32 generates the second phase signal B2 in response to rotation of the optical scroll wheel 30. That is, the second phase signal B2 is (0, 1). Then, the number of times the phase signal is changed is recorded by the controlling unit 33 (Step S2). That is, the number of times the phase signal is changed is 1. As the optical scroll wheel 30 is continuously rotated, the controlling unit 33 judges whether the number of times the phase signal is changed is larger than 1 (Step S21).

Since the number of times the phase signal is changed is 1, the controlling unit 33 will judge whether the phase signal from the light receiver 32 is changed. That is, the step S1 is performed again.

In the step S1, as the optical scroll wheel 30 is continuously rotated by the user, the light receiver 32 generates the third phase signal B3 in response to rotation of the optical scroll wheel 30. That is, the third phase signal B3 is (1, 1). Then, the number of times the phase signal is changed is recorded by the controlling unit 33 (Step S2). That is, the number of times the phase signal is changed is 2. Then, the controlling unit 33 judges whether the number of times the phase signal is changed is larger than 1 (Step S21). Since the number of times the phase signal is changed is 2, the step S22 will be performed. In the step S22, the controlling unit 33 judges whether the current phase signal (i.e. the third phase signal B3) is identical to the second previous phase signal (i.e. the first phase signal B1). Since the current phase signal is not identical to the second previous phase signal, the controlling unit 33 will perform the step S4.

In the step S4, the controlling unit 33 judges whether the number of times the phase signal is changed reaches the predetermined value. Since the number of times the phase signal is changed at this moment is 2, the number of times the phase signal is changed does not reach the predetermined value (i.e. 3). Under this circumstance, the controlling unit 33 will judge whether the phase signal from the light receiver 32 is changed. That is, the step S1 is performed again. In the step S1, as the optical scroll wheel 30 is continuously rotated by the user, the light receiver 32 generates the fourth phase signal B4 in response to rotation of the optical scroll wheel 30. That is, the fourth phase signal B4 is (1, 0). Then, the number of times the phase signal is changed is recorded by the controlling unit 33 (Step S2). That is, the number of times the phase signal is changed is 3. Then, the step S21 and the step S22 are sequentially performed. Then, the controlling unit 33 judges whether the number of times the phase signal is changed reaches the predetermined value (Step S4). Since the number of times the phase signal is changed at this moment is 3, the number of times the phase signal is changed reaches the predetermined value (i.e. 3). Then, the first look-up table T1 is inquired by the controlling unit 33 (Step S8).

Then, the controlling unit 33 compares the plural phase signals generated by the light receiver 32 with the plural first scrolling data of the first look-up table T1, and judges whether the plural phase signals comply with the plural first scrolling data of the first look-up table T1 (Step S9).

The plural phase signals include the sequential combination of the first phase signal B1→the second phase signal B2→the third phase signal B3→the fourth phase signal B4. Since the first scrolling data corresponding to the sequential combination of the first phase signal B1→the second phase signal B2→the third phase signal B3→the fourth phase signal B4 can be searched from the first look-up table T1 by the controlling unit 33, the controlling unit 33 judges that the plural phase signals comply with the plural first scrolling data of the first look-up table T1. Consequently, the scrolling signal C corresponding to the plural phase signals is outputted (Step S10). Afterwards, by the controlling unit 33, the number of times the phase signal is changed is zeroed and the current phase signal is recorded (Step S12). The current phase signal is the fourth phase signal B4, i.e. (1, 0). Then, a next sequence of the scrolling signal generation method is performed.

After the current phase signal is recorded by the controlling unit 33, the step S1 of judging whether the phase signal from the light receiver 32 is changed is performed again. In the step S1, as the optical scroll wheel 30 is continuously rotated by the user, the light receiver 32 generates the first phase signal B1 in response to rotation of the optical scroll wheel 30. That is, the first phase signal B1 is (0, 0). Then, the number of times the phase signal is changed is recorded by the controlling unit 33 (Step S2). That is, the number of times the phase signal is changed is 1. As mentioned above, the step S4 is performed, and the step S1 is performed again. As the optical scroll wheel 30 is continuously rotated by the user, the light receiver 32 generates the second phase signal B2 in response to rotation of the optical scroll wheel 30. That is, the second phase signal B2 is (0, 1). If an external factor (e.g. noise) occurs at this moment, the controlling unit 33 fails to receive the second phase signal B2. Consequently, in the step S2, the number of times the phase signal is changed, which is recorded by the controlling unit 33, is still 1. Under this circumstance, the steps S21 and the step S1 are also performed by the controlling unit 33.

In the step S1, as the optical scroll wheel 30 is continuously rotated by the user, the light receiver 32 generates the third phase signal B3 in response to rotation of the optical scroll wheel 30. That is, the third phase signal B3 is (1, 1). Then, the number of times the phase signal is changed is recorded by the controlling unit 33 (Step S2). That is, the number of times the phase signal is changed is 2. As mentioned above, the steps S21, S22 and S4 are sequentially performed, and the step S1 is performed again. In the step S1, as the optical scroll wheel 30 is continuously rotated by the user, the light receiver 32 generates the fourth phase signal B4 in response to rotation of the optical scroll wheel 30. That is, the fourth phase signal B4 is (1, 0). Then, the number of times the phase signal is changed is recorded by the controlling unit 33 (Step S2). That is, the number of times the phase signal is changed is 3. Then, the step S21 and the step S22 are sequentially performed. Then, the controlling unit 33 judges whether the number of times the phase signal is changed reaches the predetermined value (Step S4). Since the number of times the phase signal is changed at this moment is 3, the number of times the phase signal is changed reaches the predetermined value (i.e. 3). Then, the first look-up table T1 is inquired by the controlling unit 33 (Step S8).

Then, the controlling unit 33 compares the plural phase signals (i.e. B4→B1→B3→B4) generated by the light receiver 32 with the plural first scrolling data of the first look-up table T1, and judges whether the plural phase signals comply with the plural first scrolling data of the first look-up table T1 (Step S9). Since the first scrolling data corresponding to the sequential combination of B4→B1→B3→B4 can be searched from the first look-up table T1 by the controlling unit 33, the controlling unit 33 judges that the plural phase signals comply with the plural first scrolling data of the first look-up table T1. Consequently, the scrolling signal C corresponding to the plural phase signals is outputted (Step S10). Afterwards, by the controlling unit 33, the number of times the phase signal is changed is zeroed and the current phase signal is recorded (Step S12). The current phase signal is the fourth phase signal B4, i.e. (1, 0).

After the current phase signal is recorded by the controlling unit 33, as the optical scroll wheel 30 is continuously rotated by the user, the step S1 is performed by the controlling unit 33 again. Then, the above steps S1, S2, S21, S22 and S4 are repeatedly done by the controlling unit 33. Consequently, the light receiver 32 sequentially generates plural phase signals (i.e. the fourth phase signal B4→the second phase signal B2→the third phase signal B3→the first phase signal B1). Since the number of times the phase signal is changed at this moment is 3, the number of times the phase signal is changed reaches the predetermined value (i.e. 3). Then, the first look-up table T1 is inquired by the controlling unit 33 (Step S8).

Then, the controlling unit 33 compares the plural phase signals (i.e. B4→B2→B3→B1) generated by the light receiver 32 with the plural first scrolling data of the first look-up table T1, and judges whether the plural phase signals comply with the plural first scrolling data of the first look-up table T1 (Step S9). Since no first scrolling data corresponding to the sequential combination of B4→B2→B3→B1 can be searched from the first look-up table T1 by the controlling unit 33, the controlling unit 33 judges that the plural phase signals do not comply with the plural first scrolling data of the first look-up table T1. Then, by the controlling unit 33, the number of times the phase signal is changed is zeroed and the current phase signal is recorded (Step S11). The current phase signal is the first phase signal B1, i.e. (0, 0). Then, the step S1 is performed by the controlling unit 33 again.

In the step S1, if the optical scroll wheel 30 is no longer rotated by the user, the phase signal generated by the light receiver 32 is still the first phase signal B1. Under this circumstance, the controlling unit 33 judges that the phase signal is not changed (Step S1). Then, the controlling unit 33 calculates the time period of maintaining an idle status of the optical scroll wheel 30 (Step S3). Then, the controlling unit 33 judges whether the time period of maintaining the idle status of the optical scroll wheel 30 reaches the predetermined time period (Step S5). If the optical scroll wheel 30 is rotated by the user at this moment, the controlling unit 33 judges that the time period of maintaining the idle status of the optical scroll wheel 30 does not reach the predetermined time period. Correspondingly, the phase signal generated by the light receiver 32 is changed to the second phase signal B2, i.e. (0, 1). Moreover, the step S1 is performed by the controlling unit 33 again.

In the step S1, if the optical scroll wheel 30 is no longer rotated by the user, the phase signal generated by the light receiver 32 is still the second phase signal B2. Then, the controlling unit 33 calculates the time period of maintaining the idle status of the optical scroll wheel 30 (Step S3). Then, the controlling unit 33 judges whether the time period of maintaining the idle status of the optical scroll wheel 30 reaches the predetermined time period (Step S5). If the time period of maintaining the idle status of the optical scroll wheel 30 reaches the predetermined time period (i.e. 2 second), the number of times the phase signal is changed is zeroed and the current phase signal is recorded by the controlling unit 33 (Step S6). The current phase signal is the second phase signal B2, i.e. (0, 1). Then, the optical wheel mouse 3 is controlled by the controlling unit 33 to enter a sleep mode until the optical wheel mouse 3 is triggered again.

Moreover, if the first phase signal B1, the second phase signal B2 and the first phase signal B1 are sequentially performed by the controlling unit 33, the controlling unit 33 judges whether the number of times the phase signal is changed is larger than 1 (Step S21). Since the number of times the phase signal is changed is 2, the step S22 is performed. In the step S22, the controlling unit 33 judges whether the current phase signal (i.e. the first phase signal B1) is identical to the second previous phase signal (i.e. the first phase signal B1). Since the current phase signal is identical to the second previous phase signal, the controlling unit 33 judges that the optical scroll wheel 30 is reversely rotated. Under this circumstance, the step S11 is performed.

From the above discussions, the present invention provides a scrolling signal generation method. A first look-up table has been previously established in a controlling unit. By inquiring the first look-up table, the controlling unit judges whether the received phase signals can be collaboratively defined as a scrolling signal. If one of the phase signals received by the controlling unit is lost because of the external factor (e.g. noise), the subsequent phase signals are continuously received. Once a sequential combination of the subsequent plural phase signals comply with the first scrolling data of the first look-up table, the plural phase signals may be considered as a normal scrolling signal by the controlling unit. Consequently, even if noise interference occurs, the optical scroll wheel using the scrolling signal generation method of the present invention can be smoothly operated without causing the erroneous action.

It is noted that the plural first scrolling data do not always contain all kinds of phase signals. As shown in the first look-up table, the phase signals containing all kinds of phase signals or the phase signals lacking one kind of phase signal may be defined as the first scrolling data. On the other hand, the phase signals lacking two or more kinds of phase signals fail to be defined as the first scrolling data of the first look-up table. For example, the second phase signal B2 is not included in the sequential combination of the first phase signal B1→the fourth phase signal B4→the first phase signal B3→the first phase signal B1. Although the plural phase signals lack the second phase signal B2, the rotation of the optical scroll wheel 30 can result in the next first phase signal B1. That is, the second phase signal B2 excluded from the plural phase signals may be considered as a lost phase signal because of noise. In other words, since the plural phase signals lacking one kind of phase signal can be defined as a scrolling signal according to the scrolling signal generation method of the present invention, even if the noise interference occurs, the optical scroll wheel 30 can be smoothly operated.

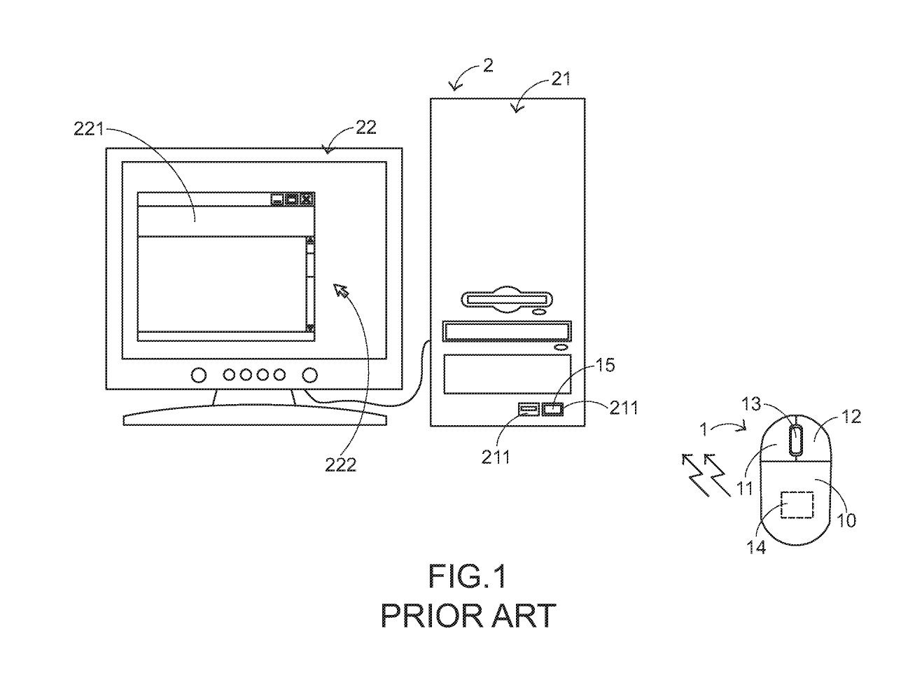

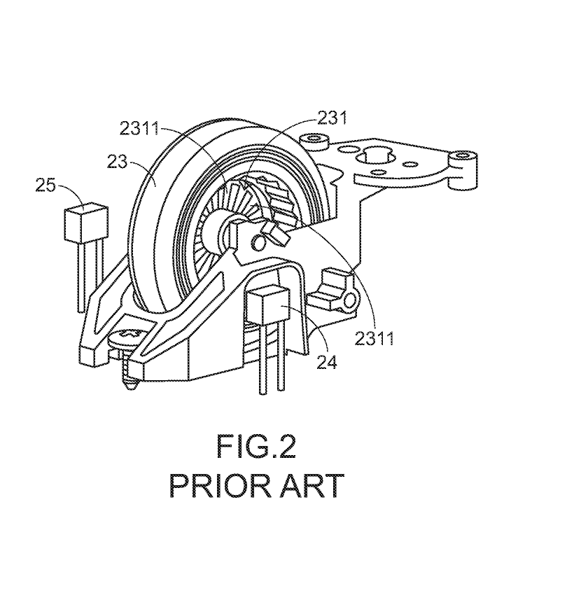

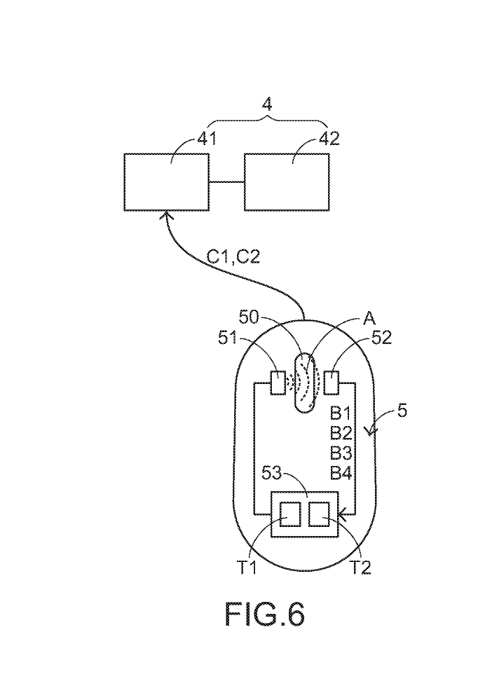

The present invention further comprises a second embodiment of an optical wheel mouse. FIG. 6 is a schematic function block diagram illustrating the communication between an optical wheel mouse and a computer system according to a second embodiment of the present invention. In FIG. 6, an optical wheel mouse 5 and a computer host 4 are shown. The computer system 4 comprises a computer host 41 and a display screen 42. The structures of the computer host 41 and the display screen 42 are similar to those of the similar to those of the conventional computer host 21 and the conventional display screen 22 as shown in FIG. 1, and are not redundantly described herein. The optical wheel mouse 5 is in communication with the computer host 41. Moreover, the optical wheel mouse 5 comprises an optical scroll wheel 50, a light emitter 51, a light receiver 52, and a controlling unit 53. Except for the following items, the structures of the optical wheel mouse 5 are similar to those of the optical wheel mouse 3 of the first embodiment, and are not redundantly described herein.

In comparison with the optical wheel mouse 3 of the first embodiment, a first look-up table T1 and a second look-up table T2 have been stored in the controlling unit 53 of the optical wheel mouse 5 of this embodiment. The first look-up table T1 comprises plural first scrolling data. Each of the first scrolling data comprises M phase signals. The contents of the first look-up table T1 are similar to those of the first embodiment. That is, M is 4. The second look-up table T2 comprises plural second scrolling data. Each of the second scrolling data is defined by N phase signals. The N phase signals comprise four kinds of phase signals, including a first phase signal B1, a second phase signal B2, a third phase signal B3, and a fourth phase signal B4.

The details contents of the plural first scrolling data of the first look-up table T1 and the second look-up table T2 will be illustrates as follows. The plural first scrolling data of the first look-up table T1 have been previously stored in the controlling unit 53. Each of the plural first scrolling data may be considered as a rotating graduation, i.e. a first scrolling signal. The plural first scrolling data comprise 32 kinds of combinations. These kinds of combinations are similar to those of the first embodiment, and are not redundantly described herein. The plural second scrolling data of the second look-up table T2 have been previously stored in the controlling unit 53. Each of the plural second scrolling data may be considered as a rotating graduation, i.e. a second scrolling signal. The plural second scrolling data comprise 40 kinds of combinations. The 40 kinds of combinations are listed in the following table.

| | |
|---|---|
| B1→B2→B3→B4→B1 | B1→B4→B3→B2→B1 |
| B2→B3→B4→B1→B2 | B2→B1→B4→B3→B2 |
| B3→B4→B1→B2→B3 | B3→B2→B1→B4→B3 |
| B4→B1→B2→B3→B4 | B4→B3→B2→B1→B4 |
| B1→B2→B3→B4→B2 | B2→B4→B3→B2→B1 |
| B1→B2→B3→B1→B2 | B2→B1→B3→B2→B1 |
| B1→B2→B4→B1→B2 | B2→B1→B4→B2→B1 |
| B1→B3→B4→B1→B2 | B2→B1→B4→B3→B1 |
| B2→B3→B4→B1→B3 | B3→B1→B4→B3→B2 |
| B2→B3→B4→B2→B3 | B3→B2→B4→B3→B2 |
| B2→B3→B1→B2→B3 | B3→B2→B1→B3→B2 |
| B2→B4→B1→B2→B3 | B3→B2→B1→B4→B2 |
| B3→B4→B1→B2→B4 | B4→B2→B1→B4→B3 |
| B3→B4→B1→B3→B4 | B4→B3→B1→B4→B3 |
| B3→B4→B2→B3→B4 | B4→B3→B2→B4→B3 |
| B3→B1→B2→B3→B4 | B4→B3→B2→B1→B3 |
| B4→B1→B2→B3→B1 | B1→B3→B2→B1→B4 |
| B4→B1→B2→B4→B1 | B1→B4→B2→B1→B4 |
| B4→B1→B3→B4→B1 | B1→B4→B3→B1→B4 |
| B4→B2→B3→B4→B1 | B1→B4→B3→B2→B4 |

The plural second scrolling data in the left column of the second look-up table T2 denote the sequential combinations of the plural phase signals which are generated in response to the rotation of the optical scroll wheel 50 along a first direction. The plural second scrolling data in the right column of the second look-up table T2 denote the sequential combinations of the plural phase signals which are generated in response to the rotation of the optical scroll wheel 50 along a second direction, wherein the second direction is reverse to the first direction. Each of the second scrolling data comprises 5 phase signals (i.e. N=5). When the optical wheel mouse 5 is operated in a normal scrolling mode, the first look-up table T1 is used. On the other hand, when the optical wheel mouse 5 is operated in a fast scrolling mode, the second look-up table T2 is used.

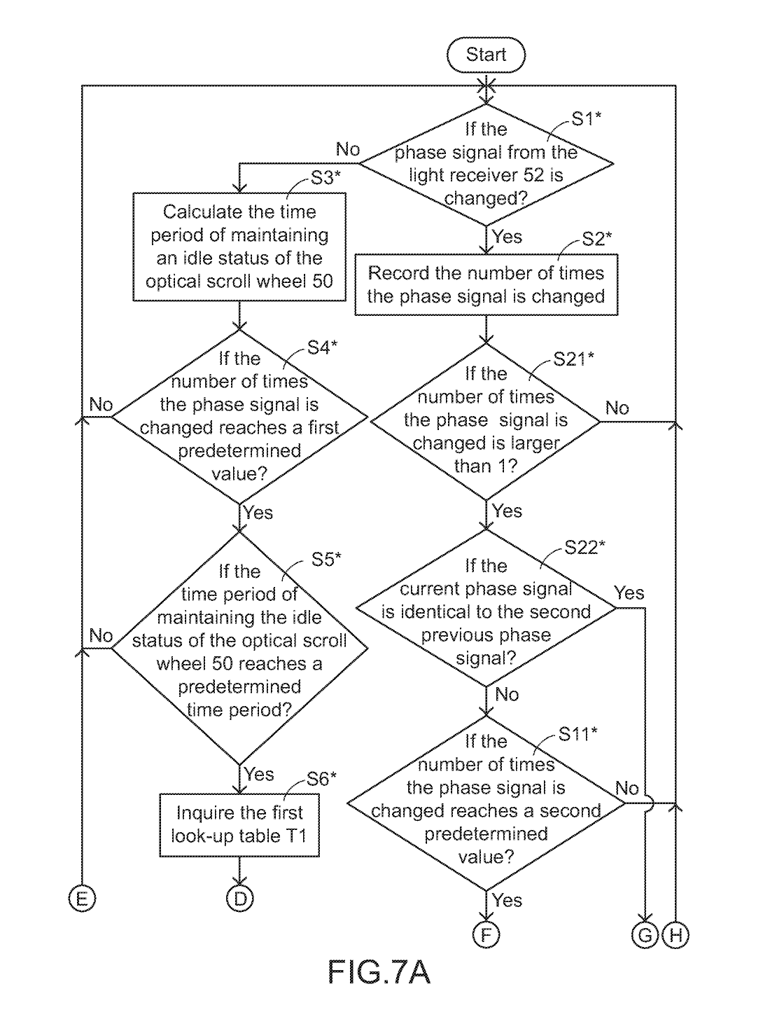

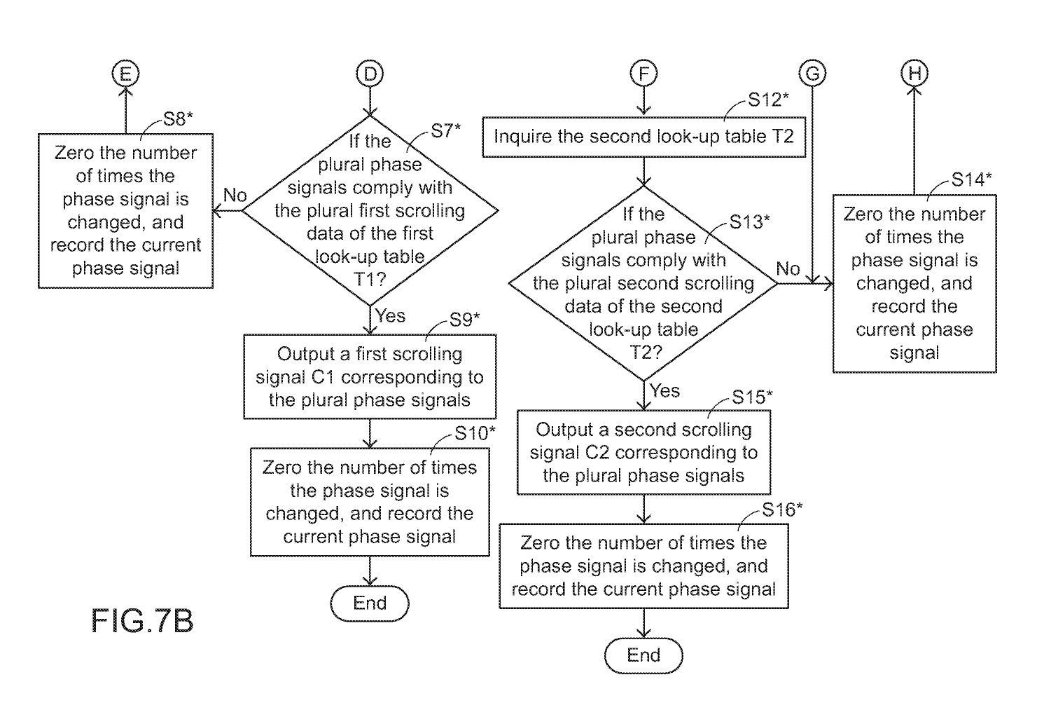

Hereinafter, a scrolling signal generation method for the optical wheel mouse of the second embodiment of the present invention will be illustrated with reference to FIGS. 7A and 7B. FIGS. 7A and 7B schematically illustrate a flowchart of a scrolling signal generation method for the optical wheel mouse of the second embodiment of the present invention. The scrolling signal generation method comprises the following steps.

The step S1* is performed to judge whether the phase signal from the light receiver 52 is changed. In the step S2*, the number of times the phase signal is changed is recorded. In the step S3*, the time period of maintaining an idle status of the optical scroll wheel 50 is calculated. The step S4* is performed to judge whether the number of times the phase signal is changed reaches a first predetermined value. The step S5* is performed to judge whether the time period of maintaining the idle status of the optical scroll wheel 50 reaches a predetermined time period. In the step S6*, the first look-up table T1 is inquired. The step S7* is performed to judge whether the plural phase signals comply with the plural first scrolling data of the first look-up table T1. In the step S8*, the number of times the phase signal is changed is zeroed, and the current phase signal is recorded. In the step S9*, a first scrolling signal C1 corresponding to the plural phase signals is outputted. In the step S10*, the number of times the phase signal is changed is zeroed, and the current phase signal is recorded. The step S11* is performed to judge whether the number of times the phase signal is changed reaches a second predetermined value. In the step S12*, the second look-up table T2 is inquired. The step S13* is performed to judge whether the plural phase signals comply with the plural second scrolling data of the second look-up table T2. In the step S14*, the number of times the phase signal is changed is zeroed, and the current phase signal is recorded. In the step S15*, a second scrolling signal C2 corresponding to the plural phase signals is outputted. In the step S16*, the number of times the phase signal is changed is zeroed, and the current phase signal is recorded.

In the step S1*, if the phase signal is changed, the step S2* is performed. Whereas, if the phase signal is not changed, the step S3* is performed. In the step S4*, if the number of times the phase signal is changed reaches the first predetermined value, the step S5* is performed. Whereas, if the number of times the phase signal is changed does not reach the first predetermined value, the step S1* is performed again. In the step S5*, if the time period of maintaining the idle status of the optical scroll wheel 50 reaches the predetermined time period, the step S6* is performed. Whereas, if the time period of maintaining the idle status of the optical scroll wheel 50 does not reach the predetermined time period, the step S1* is performed again.

In the step S7*, if the plural phase signals comply with the plural first scrolling data of the first look-up table T1, the step S9* is performed. Whereas, if the plural phase signals do not comply with the plural first scrolling data of the first look-up table T1, the step S8* is performed. In the step S11*, if the number of times the phase signal is changed reaches the second predetermined value, the step S12* is performed. Whereas, if the number of times the phase signal is changed does not reach the second predetermined value, the step S1* is performed again. In the step S13*, if the plural phase signals comply with the plural second scrolling data of the second look-up table T2, the step S15* is performed. Whereas, if the plural phase signals do not comply with the plural second scrolling data of the second look-up table T2, the step S14* is performed. After the step S10* or the step S16* is performed, the step S1* is automatically executed by the optical wheel mouse 5 again. Consequently, the scrolling signal generation method of the present invention can be repeatedly performed.

In an embodiment, the first predetermined value is three, the second predetermined value is four, and the predetermined time period is 32 milliseconds. The first predetermined value, the second predetermined value and the predetermined time period are previously set in the controlling unit 53 during the process of fabricating the optical wheel mouse 5. The scrolling signal generation method of the present invention further comprises a reverse rotation judgment mechanism. The reverse rotation judgment mechanism is performed after the step S2*. The reverse rotation judgment mechanism comprises the step S21* and S22*. The step S21* is performed to judge whether the number of times the phase signal is changed is larger than 1. The step S22* is performed to judge whether the current phase signal is identical to the second previous phase signal. The reverse rotation judgment mechanism of this embodiment is identical to that of the reverse rotation judgment mechanism of the first embodiment, and is not redundantly described herein.

Hereinafter, the operations of the scrolling signal generation method according to the present invention will be illustrated with reference to FIGS. 6, 7A and 7B again. If the optical scroll wheel 50 is not triggered, it is assumed that the phase signal generated by the light receiver 52 is the first phase signal B1. That is, the first phase signal B1 is (0, 0). After the optical wheel mouse 5 is electrically powered on, the scrolling signal generation method of the present invention is started. Firstly, the controlling unit 53 judges whether the phase signal from the light receiver 52 is changed (Step S1*). When the optical scroll wheel 50 is rotated by the user, the light receiver 52 generates the second phase signal B2 in response to rotation of the optical scroll wheel 50. That is, the second phase signal B2 is (0, 1). Then, the number of times the phase signal is changed is recorded by the controlling unit 53 (Step S2*). That is, the number of times the phase signal is changed is 1. As the optical scroll wheel 50 is continuously rotated, the controlling unit 53 judges whether the number of times the phase signal is changed is larger than 1 (Step S21*). Since the number of times the phase signal is changed is 1, which is not larger than 1, the controlling unit 53 will judge whether the phase signal from the light receiver 52 is changed. That is, the step S1* is performed again.

As the optical scroll wheel 50 is continuously rotated by the user, the steps S1*, the step S2* and the step S21* are sequentially performed by the controlling unit 53. Meanwhile, in response to rotation of the optical scroll wheel 50, the light receiver 52 generates the third phase signal B3. That is, the third phase signal B3 is (1, 1). Moreover, the number of times the phase signal is changed is recorded by the controlling unit 53. That is, the number of times the phase signal is changed is 2. In the step S22*, the controlling unit 53 judges whether the current phase signal (i.e. the third phase signal B3) is identical to the second previous phase signal (i.e. the first phase signal B1). Since the current phase signal is not identical to the second previous phase signal according to the comparing result, the controlling unit 53 judges whether the number of times the phase signal is changed reaches the second predetermined value (Step S11*). Since the number of times the phase signal is changed is 2, which is not larger than the second predetermined value (i.e. 4), the controlling unit 53 will judge whether the phase signal from the light receiver 52 is changed. That is, the step S1* is performed again.

As the optical scroll wheel 50 is continuously rotated by the user, the steps S1*, the step S2*, the step S21*, the step S22* and the step S11* are sequentially performed by the controlling unit 53. Meanwhile, in response to rotation of the optical scroll wheel 50, the light receiver 52 generates a fourth phase signal B4. That is, the fourth phase signal B4 is (1, 0). Moreover, the number of times the phase signal is changed is recorded by the controlling unit 53. That is, the number of times the phase signal is changed is 3. In the step S11*, since the number of times the phase signal is changed is 3, which is not larger than the second predetermined value (i.e. 4), the controlling unit 53 will judge whether the phase signal from the light receiver 52 is changed. That is, the step S1* is performed again.

During the step S1* is performed by the controlling unit 53 again, if the rotation of the optical scroll wheel 50 is stopped, the controlling unit 53 judges that the phase signal from the light receiver 52 is not changed. Then, the controlling unit 53 calculates the time period of maintaining an idle status of the optical scroll wheel 50 (Step S3*). Then, in the step S4*, the controlling unit 53 judges whether the number of times the phase signal is changed reaches the first predetermined value (i.e. 3). Since the number of times the phase signal is changed is 3, which is equal to the first predetermined value, the controlling unit 53 judges whether the time period of maintaining the idle status of the optical scroll wheel 50 reaches the predetermined time period (Step S5*). If the time period of maintaining the idle status of the optical scroll wheel 50 reaches the predetermined time period (i.e. 32 millisecond), the controlling unit 53 inquires the first look-up table T1 (Step S6*).

Then, the controlling unit 53 compares the plural phase signals generated by the light receiver 52 with the plural first scrolling data of the first look-up table T1, and judges whether the plural phase signals comply with the plural first scrolling data of the first look-up table T1 (Step S7*).

The plural phase signals include the sequential combination of the first phase signal B1→the second phase signal B2→the third phase signal B3→the fourth phase signal B4. Since the first scrolling data corresponding to the sequential combination of the first phase signal B1→the second phase signal B2→the third phase signal B3→the fourth phase signal B4 can be searched from the first look-up table T1 by the controlling unit 53, the controlling unit 53 judges that the plural phase signals comply with the plural first scrolling data of the first look-up table T1. Consequently, the first scrolling signal C1 corresponding to the plural phase signals is outputted (Step S9*). Afterwards, by the controlling unit 53, the number of times the phase signal is changed is zeroed and the current phase signal is recorded (Step S10*). The current phase signal is the fourth phase signal B4, i.e. (1, 0). Then, a next sequence of the scrolling signal generation method is performed. The process of generating the first scrolling signal C1 by the optical wheel mouse 5 in the normal scrolling mode has been described above.

The operations of the optical wheel mouse 5 in the fast scrolling mode will be illustrated in more details as follows. As mentioned above, the current phase signal is the fourth phase signal B4, i.e. (1, 0). As the optical scroll wheel 50 is continuously rotated by the user, the steps S1*, the step S2*, the step S21* and the step S22* are sequentially performed by the controlling unit 53. Consequently, the fourth phase signal B4, the first phase signal B1, the second phase signal B2 and the third phase signal B3 are sequentially received by the controlling unit 53. In addition, the number of times the phase signal is changed is 3. Then, the controlling unit 53 judges whether the phase signal from the light receiver 52 is changed (Step S1*). As the optical scroll wheel 50 is continuously rotated by the user, the light receiver 52 generates the fourth phase signal B4 in response to rotation of the optical scroll wheel 50. That is, the fourth phase signal B4 is (1, 0). If an external factor (e.g. noise) occurs at this moment, the light receiver 52 fails to be triggered. Under this circumstance, the light receiver 52 is unable to generate the fourth phase signal B4. Consequently, the controlling unit 53 judges that the phase signal from the light receiver 52 is not changed. Then, the controlling unit 53 calculates the time period of maintaining the idle status of the optical scroll wheel 50 (Step S3*). The number of times the phase signal is changed is still 3.

The steps S4* and the step S5* are sequentially performed by the controlling unit 53. In the step S5*, as the optical scroll wheel 50 is continuously rotated, the controlling unit 53 judges whether the phase signal from the light receiver 52 is changed again (Step S1*). Then, the steps S1*, the step S2*, the step S21*, the step S22* and the step S11* are sequentially performed by the controlling unit 53 again. Meanwhile, in response to rotation of the optical scroll wheel 50, the light receiver 52 generates the first phase signal B1. That is, the first phase signal B1 is (0, 0). In addition, the number of times the phase signal is changed is 4. In the step S11*, since the controlling unit 53 judges that the number of times the phase signal is changed reaches the second predetermined value (i.e. 4), the controlling unit 53 will inquire the second look-up table T2 (Step S12*).

Then, the controlling unit 53 compares the plural phase signals generated by the light receiver 52 with the plural second scrolling data of the second look-up table T2, and judges whether the plural phase signals comply with the plural second scrolling data of the second look-up table T2 (Step S13*). The plural phase signals include the sequential combination of the fourth phase signal B4→the first phase signal B1→the second phase signal B2→the third phase signal B3→the first phase signal B1. Since the second scrolling data corresponding to the sequential combination of the fourth phase signal B4→the first phase signal B1→the second phase signal B2→the third phase signal B3→the first phase signal B1 can be searched from the second look-up table T2 by the controlling unit 53, the controlling unit 53 judges that the plural phase signals comply with the plural second scrolling data of the second look-up table T2. Consequently, the second scrolling signal C2 corresponding to the plural phase signals is outputted (Step S15*). Afterwards, by the controlling unit 53, the number of times the phase signal is changed is zeroed and the current phase signal is recorded (Step S16*). The current phase signal is the first phase signal B1, i.e. (0, 0). Then, a next sequence of the scrolling signal generation method is performed. The process of generating the second scrolling signal C2 by the optical wheel mouse 5 in the fast scrolling mode has been described above.

In the above embodiment, the optical wheel mouse can be operated in two scrolling modes by implementing the scrolling signal generation method of the present invention. The two scrolling mode include the normal scrolling mode and the fast scrolling mode. A first look-up table and a second look-up table have been previously established in a controlling unit. By inquiring the first look-up table or the second look-up table, the controlling unit judges whether the received phase signals can be collaboratively defined as a first scrolling signal or a second scrolling signal. If one of the phase signals received by the controlling unit is lost because of the external factor (e.g. noise), the subsequent phase signals are continuously received. Once a sequential combination of the subsequent plural phase signals comply with the first scrolling data of the first look-up table or the second scrolling data of the second look-up table, the plural phase signals may be considered as a normal scrolling signal by the controlling unit.

From the above descriptions, according to the scrolling signal generation method of the present invention, two criteria for generating the scrolling signal have been previously set. The first criterion is satisfied when the first phase signal, the second phase signal, the third phase signal, the fourth phase signal and the first phase signal are sequentially generated or when the fourth phase signal, the third phase signal, the second phase signal, the first phase signal and the fourth phase signal are sequentially generated. The second criterion is satisfied when only one kind of phase signal is not included in the plural phase signals. The first scrolling data and the second scrolling data complying with the above criteria are recorded in the first look-up table or the second look-up table, respectively. Since the scrolling signal generation method of the present invention can be used to search the phase signals lacking one kind of phase signal from the first look-up table or the second look-up table, the possibility of causing the erroneous action will be eliminated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A scrolling signal generation method for an optical wheel mouse, said optical wheel mouse comprising an optical scroll wheel, a light emitter and a light receiver, said scroll wheel being rotatable by a user, said light emitter generating an optical signal, said optical signal passing through said scroll wheel being received by said light receiver, said light receiver outputting plural phase signals according to said optical signal, said scrolling signal generation method comprises steps of:
judging whether said phase signal from said light receiver is changed;
judging whether a number of times said phase signal is changed reaches a predetermined value, wherein if said number of times said phase signal is changed reaches said predetermined value, a first look-up table is inquired, wherein said first look-up table contains plural first scrolling data, and each of said plural first scrolling data is defined by plural phase signals; and
judging whether said plural phase signals generated in response to rotation of said optical scroll wheel comply with said plural first scrolling data of the first look-up table, wherein if said plural phase signals comply with said plural first scrolling data of the first look-up table, a scrolling signal corresponding to said plural phase signals is outputted, wherein if said plural phase signals do not comply with said plural first scrolling data of the first look-up table, said number of times said phase signal is changed is zeroed and said current phase signal is recorded, and said step of judging whether said phase signal from said light receiver is changed is performed again.

2. The scrolling signal generation method according to claim 1, wherein if said phase signal is not changed, said scrolling signal generation method further comprises a step of calculating a time period of maintaining an idle status of said optical scroll wheel, wherein if said phase signal is changed, said scrolling signal generation method further comprises a step of recording said number of times said phase signal is changed.

3. The scrolling signal generation method according to claim 2, wherein after said step of calculating said time period of maintaining said idle status of said optical scroll wheel, said scrolling signal generation method further comprises a step of judging whether said time period of maintaining said idle status of said optical scroll wheel reaches a predetermined time period, wherein if said time period of maintaining said idle status of said optical scroll wheel reaches said predetermined time period, said optical scroll wheel is controlled to enter a sleep mode, wherein if said time period of maintaining said idle status of said optical scroll wheel does not reach said predetermined time period, said step of judging whether said phase signal from said light receiver is changed is performed again.

4. The scrolling signal generation method according to claim 1, wherein if said number of times said phase signal is changed does not reach said predetermined value, said step of judging whether said phase signal from said light receiver is changed is performed again.

5. The scrolling signal generation method according to claim 1, wherein after said scrolling signal corresponding to said plural phase signals is outputted, said step of judging whether said phase signal from said light receiver is changed is performed again.

6. A scrolling signal generation method for an optical wheel mouse, said optical wheel mouse comprising an optical scroll wheel, a light emitter and a light receiver, said scroll wheel being rotatable by a user, said light emitter generating an optical signal, said optical signal passing through said scroll wheel being received by said light receiver, said light receiver outputting plural phase signals according to said optical signal, said scrolling signal generation method comprises steps of:
judging whether said phase signal from said light receiver is changed;
selectively inquiring a first look-up table or a second look-up table, wherein if said number of times said phase signal is changed reaches a first predetermined value and a time period of maintaining an idle status of said optical scroll wheel reaches a predetermined time period, said first look-up table is inquired, wherein if said number of times said phase signal is changed reaches a second predetermined value which is larger than said first predetermined value, said second look-up table is inquired, wherein said first look-up table contains plural first scrolling data, and each of said plural first scrolling data is defined by M phase signals, wherein said second look-up table contains plural second scrolling data, and each of said plural second scrolling data is defined by N phase signals, where N is larger than M;
judging whether said plural phase signals generated in response to rotation of said optical scroll wheel comply with said plural first scrolling data of the first look-up table or comply with said plural second scrolling data of the second look-up table; and
outputting a first scrolling signal corresponding to said plural phase signals or a second scrolling signal corresponding to said plural phase signals.

7. The scrolling signal generation method according to claim 6, wherein if said phase signal is not changed, said scrolling signal generation method further comprises a step of calculating said time period of maintaining said idle status of said optical scroll wheel, wherein if said phase signal is changed, said scrolling signal generation method further comprises a step of recording said number of times said phase signal is changed.

8. The scrolling signal generation method according to claim 7, wherein after said step of calculating said time period of maintaining said idle status of said optical scroll wheel, said scrolling signal generation method further comprises a step of judging whether said first look-up table is inquired, wherein after said step of recording said number of times said phase signal is changed, said scrolling signal generation method further comprises a step of judging whether said second look-up table is inquired.

9. The scrolling signal generation method according to claim 8, wherein said step of judging whether said first look-up table is inquired is performed by steps of:
judging whether said number of times said phase signal is changed reaches said first predetermined value; and
judging whether said time period of maintaining said idle status of said optical scroll wheel reaches said predetermined time period.

10. The scrolling signal generation method according to claim 9, wherein if said number of times said phase signal is changed does not reach said first predetermined value, said step of judging whether said phase signal from said light receiver is changed is performed again, wherein if said number of times said phase signal is changed reaches said first predetermined value, said step of judging whether said time period of maintaining said idle status of said optical scroll wheel reaches said predetermined time period is performed.

11. The scrolling signal generation method according to claim 10, wherein if said time period of maintaining said idle status of said optical scroll wheel reaches said predetermined time period, said first look-up table is inquired, wherein if said time period of maintaining said idle status of said optical scroll wheel does not reach said predetermined time period, said step of judging whether said phase signal from said light receiver is changed is performed again.

12. The scrolling signal generation method according to claim 6, wherein if said number of times said phase signal is changed does not reach said second predetermined value, said step of judging whether said phase signal from said light receiver is changed is performed again.

13. The scrolling signal generation method according to claim 6, wherein after said first scrolling signal corresponding to said plural phase signals or said first scrolling signal corresponding to said plural phase signals is outputted, said step of judging whether said phase signal from said light receiver is changed is performed again.
